(19) United States
(12) Patent Application Publication
(10) Pub. No.: US 2015/0254098 A1
(43) Pub. Date: Sep. 10, 2015

(54) TRANSACTION PROCESSING APPARATUS AND DISTRIBUTED PROCESSING SYSTEM

(71) Applicant: FUJITSU LIMITED, Kawasaki-shi (JP)

(72) Inventor: Munenori MAEDA, Yokohama (JP)

(21) Appl. No.: 14/631,139

(22) Filed: Feb. 25, 2015

(30) Foreign Application Priority Data
Mar. 5, 2014 (JP) 2014-043344

(51) Int. Cl. G06F 9/46; G06F 17/30

(52) U.S. Cl. CPC G06F 9/467; G06F 17/30371

(57) ABSTRACT

A storage stores target data to be processed. A first and second processing apparatuses makes a request to process the target data. The first processing apparatus includes a processor and an interface. The processor makes a request for the storage to perform a first updating process on the target data. The interface transmits a request signal to the second processing apparatus after the first updating process ends, the request signal being for making a request to start a second updating process indivisible from the first updating process. After a request to perform the second updating process is made, when the processor obtains information indicating that the target data has been subjected to a process that the first processing apparatus has made a request to perform, the processor makes a request for the storage to return the target data to a state before the first updating process.

### CROSS-REFERENCE TO RELATED APPLICATION

This application is based upon and claims the benefit of priority of the prior Japanese Patent Application No. 2014-043344, filed on Mar. 5, 2014, the entire contents of which are incorporated herein by reference.

### FIELD

The embodiments discussed herein are related to transaction processing.

### BACKGROUND

In processing that uses a database, a distributed transaction may be used. Distributed transaction processing is an indivisible information processing sequence in which a plurality of servers refer to or update a database during one transaction. An exemplary indivisible information processing sequence is a situation in which money is transferred from an account A of a bank to an account B thereof.

Assume that a system for managing data on accounts includes, for example, a DB server provided with a database that stores data on a bank account, and a plurality of servers that perform an updating process for the database. In distributed transaction processing wherein money is transferred from an account A to an account B, a server that sends, to a DB server, a subtraction request for subtracting a transaction amount from data on the account A is different from a server that sends, to the DB server, an addition request for adding the transaction amount to data on the account B. The server that sends a subtraction request first sends, to the DB server, a subtraction request for subtracting a transaction amount from data on the account A. In accordance with the request, the DB server performs a process of subtracting the transaction amount from data on the account A. The server that makes a subtraction request commits the subtraction process on the database (finalizing process). The committing performed by the server that makes a subtraction request perpetuates updated data. Next, the server that makes an addition request sends, to the DB server, an addition request to add the transaction amount to data on the account B. In accordance with the request, the DB server performs a process of adding the transaction amount to data on the account B. The server that makes an addition request commits the addition process on the database. In this way, in a transfer process wherein an addition process and a subtraction process are finished normally, data consistency is ensured between accounts.

For processing related to bank accounts, to prevent money from being erroneously charged twice when processing fails, contents of a database of a server in which an error has been detected are, in many cases, returned to a state before processing (rollback). However, consistency may be lost because different servers perform subtraction from a payer account and addition to a payee account. When a subtraction process on an account A is committed while an addition process on an account B fails, a DB server rolls back data on the failed account B. This could lead to a situation in which, in spite of the rollback of the addition process on the account B, the subtraction process on the account A is not rolled back. A two-phase commit technology is known wherein, to prevent such inconsistency, an addition process and a subtraction process are performed on a database, and, when any of these processes fails, both of the processes are rolled back.

For transaction processing for maintaining data consistency, a technology is known wherein transactions are divided into groups, and each of the groups is processed as a set so as to assure an ACID processing result (see for example patent document 1).

As a technology related to transaction processing, a technology is known for decreasing processing of a communication between members separately operated during sync-point processing (see for example patent document 2).

As a technology related to transaction processing, a technology is known wherein signals indicating “usable” or “nonusable” are received from a plurality of agents, a commit or backout decision is made by a coordinator so as to provide synchronization of transaction processing (see for example patent document 3).

Patent document 1: Japanese Laid-open Patent Publication No. 10-069418

Patent document 2: Japanese Laid-open Patent Publication No. 2001-306381

Patent document 3: Japanese National Publication of International Patent Application No. 10-510651

### SUMMARY

A system includes a storage, a first and second processing apparatuses. The storage stores target data to be processed. The first and second processing apparatuses makes a request to process the target data. The first processing apparatus includes a processor and an interface. The processor makes a request for the storage to perform a first updating process on the target data. The interface transmits a request signal to the second processing apparatus after the first updating process ends, the request signal being for making a request to start a second updating process indivisible from the first updating process. After a request to perform the second updating process is made, when the processor obtains information indicating that the target data has been subjected to a process that the first processing apparatus has made a request to perform, the processor makes a request for the storage to return the target data to a state before the first updating process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a system diagram illustrating an example of distributed transaction processing in accordance with an embodiment;

FIG. 2 illustrates an exemplary hardware configuration of a server or DB server;

FIG. 3 is a sequence diagram illustrating an example of distributed transaction processing performed when a fault has not occurred;

FIG. 4 is a sequence diagram illustrating an exemplary process performed in a system when handshaking fails (example 1);

FIG. 5 is a sequence diagram illustrating an exemplary process performed in a system when handshaking fails (example 2);

FIG. 6 is a sequence diagram illustrating an exemplary situation in which a response signal is transmitted that indicates that transaction processing has failed;

FIG. 7 is a sequence diagram illustrating an example of transaction processing performed when a response signal is delayed (example 1);

FIG. 8 is a sequence diagram illustrating an example of transaction processing performed when a response signal is delayed (example 2);

FIG. 9A is a flowchart illustrating an example of transaction processing performed on a server-A side in accordance with an embodiment;

FIG. 9B is a flowchart illustrating an example of transaction processing performed on a server-A side in accordance with an embodiment;

FIG. 9C is a flowchart illustrating an example of transaction processing performed on a server-A side in accordance with an embodiment;

FIG. 9D is a flowchart illustrating an example of transaction processing performed on a server-A side in accordance with an embodiment;

FIG. 10A is a flowchart illustrating an example of transaction processing performed on a server-B side in accordance with an embodiment;

FIG. 10B is a flowchart illustrating an example of transaction processing performed on a server-B side in accordance with an embodiment;

FIG. 11 is a sequence diagram illustrating an example of distributed transaction processing wherein a response signal corresponding to an RPC signal is not used (example 1);

FIG. 12 is a sequence diagram illustrating an example of distributed transaction processing wherein a response signal corresponding to an RPC signal is not used (example 2);

FIG. 13 is a sequence diagram illustrating an example of distributed transaction processing wherein a response signal corresponding to an RPC signal is not used (example 3);

FIG. 14 is a sequence diagram illustrating an example of distributed transaction processing wherein a response signal corresponding to an RPC signal is not used (example 4); and

FIG. 15 is a sequence diagram illustrating an example of distributed transaction processing wherein a response signal corresponding to an RPC signal is not used (example 5).

### DESCRIPTION OF EMBODIMENTS

When an addition process or subtraction process included in one transaction processing sequence fails, data consistency cannot be ensured without rolling back both of the processes. To secure consistency in the performing of a distributed transaction, servers within a system will be replaced with servers adapted to two-phase commit. However, such servers could be very expensive in comparison with servers that are not adapted to two-phase commit, and troublesome tasks could need to be performed for the replacing. It is highly likely that a fault will occur when a database holding account data is updated during a task, and hence, in one possible example, the database is made to be unusable. This makes the entirety of the system unusable until the adding of a system adapted to two-phase commit is finished. A task could be performed for reflecting data on a transaction between accounts performed during a task in a database. Thus, it is difficult to replace all of the servers with servers adapted to two-phase commit. Such a problem is not limited to the case of accounts, and a similar problem could occur when a server that is not adapted to two-phase commit performs a distributed transaction.

In one aspect, an object of embodiments is to readily ensure data consistency in a distributed transaction.

The following will describe embodiments in detail with reference to the drawings.

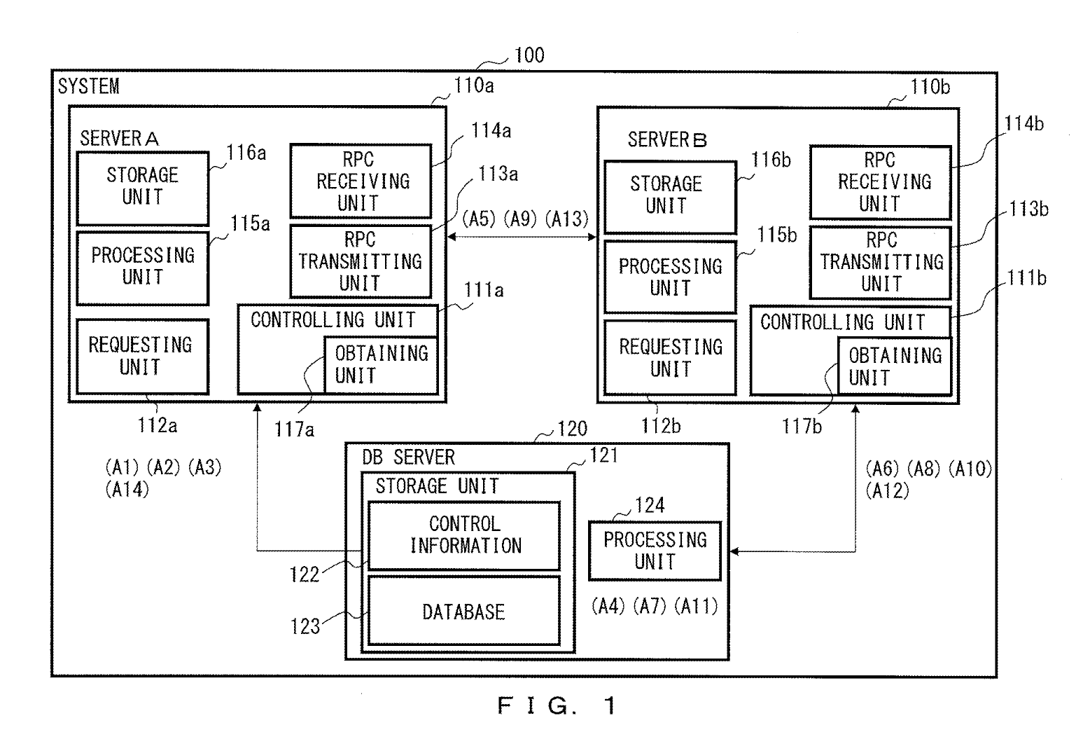

FIG. 1 is a system configuration diagram illustrating an example of distributed transaction processing in accordance with an embodiment. With reference to FIG. 1, descriptions will be given of an exemplary situation in which distributed transaction processing is a process of transferring money from an account A to an account B. A system 100 that manages account data includes, for example, a DB server 120 provided with a database 121 that holds bank account data, and a plurality of servers 110 (110a, 110b) that perform an updating process on the database 121. The servers 110 are connected to the DB server 120 over a network. The DB server 120 holds a storage region in which is stored data that all of the servers 110 can refer to. The DB server 120 and the servers 110 do not limit the number of servers.

The server 110 includes a controlling unit 111, a requesting unit 112, an RPC (Remote Procedure Call) transmitting unit 113, an RPC receiving unit 114, a processing unit 115, and a storage unit 116. In the updating of data within the database 121, the controlling unit 111 controls a synchronization primitive used to avoid conflict with another process. An obtaining unit 117 included in the controlling unit 111 obtains information from control information 122. The requesting unit 112 outputs to the DB server 120 a request to update data within the database 121.

The RPC transmitting unit 113 and the RPC receiving unit 114 transmit and receive messages (RPCs) used in an inter-server call process performed to achieve consistency between the servers 111a and 111b. In one possible example, an RPC is a request signal sent from the server 111a to the server 111b to make a request for the server 111b to perform processing. The processing unit 115 performs processing that a request to perform has been made using an RPC. The storage unit 116 stores data to be used by the controlling unit 111, the requesting unit 112, the RPC transmitting unit 113, the RPC receiving unit 114, and the processing unit 115.

The DB server 120 includes a storage unit 121 and a processing unit 124. The processing unit 124 performs processing in accordance with a request from the server 110. The storage unit 121 includes control information 122 and a database 123. Control information 122 is updated by a synchronization primitive transmitted from the controlling unit 111, and is used by each server to check the status of data that is being updated. The database 123 holds information on, for example, money in accounts. Control information 122 is stored in a storage region that every server 111 can access.

Distributed transaction processing wherein money is transferred from an account A to an account B is an indivisible process in which a subtraction request for subtracting a transaction amount from data on the account A and an addition request for adding the transaction amount to data on the account B are reported to the DB server 120.

In (A1)-(A14) below, descriptions will be given of distributed transaction processing in accordance with an embodiment with reference to a situation in which a fault has not occurred. In a sequence of the indivisible processes, i.e., a subtraction process on the account A and an addition process on the account B, a program for starting distributed transaction processing is activated starting from the server-110a side.

(A1) The controlling unit 111a of the server 110a reports to the DB server 120 a signal for writing a check record to the DB server 120, the check record being information used by the server 110a to check that an RPC process has started on the server-110b side. The signal for writing a check record is achieved by a primitive. In one possible example, a putIfAbsent instruction is used as a primitive for the signal for writing a check record. The putIfAbsent instruction has a property such that incomplete data cannot be observed from another process until transaction processing is completed. A primitive that uses the putIfAbsent instruction will hereinafter be referred to as a primitive (putIfAbsent).

(A2) The processing unit 124 of the DB server 120 causes the storage unit 121 to store control information indicating that the RPC process on the server-110b side has not started. The control information may include information indicating that processing is a request process from the server 110a.

(A3) A requesting unit 112a of the server 110a sends to the DB server 120 a subtraction request for subtracting a transaction amount from data on the account A.

(A4) In accordance with the request, the processing unit 123 of the DB server 120 performs a process of subtracting the transaction amount from data on the account A. At that moment, the server 110a does not commit update of data on the account A.

(A5) The subtraction process on the account A and the addition process on the account B constitute a sequence of indivisible processes. Hence, before committing data on the account A, an RPC transmitting unit 113a of the server 110a transmits an RPC signal to the server 110b, i.e., a server that updates data on the account B. The RPC signal is a request to start a process of adding money subtracted from the account A to the account B. An RPC receiving unit 113b of the server 110b receives the RPC signal.

(A6) The server 110b starts transaction processing. The controlling unit 111b of the server 110b reports to the DB server 120 a signal indicating that the server 110b has started the RPC process. The signal indicating that the RPC process has started is achieved by, for example, a primitive. In one possible example, a remove instruction is used as a primitive for the signal indicating that the RPC process has started. The remove instruction is an instruction for removing a state in which the primitive (putIfAbsent) prevents incomplete data from being observed from another process. A primitive that uses the remove instruction will hereinafter be referred to as a primitive (remove).

(A7) The processing unit 124 of the DB server 120 deletes, from the storage unit 121, control information (check record) indicating that the RPC process on the server-110b side has not started.

(A8) The controlling unit 111b of the server 110b reports to the DB server 120 a signal for writing a cancel record to the DB server 120, the cancel record being information used by the server 110a to check whether the RPC process on the server-110b side has failed. The signal for writing a cancel record is achieved by a primitive. In one possible example, the putIfAbsent instruction is used as a primitive for the signal for writing a cancel record. The processing unit 124 of the DB server 120 causes the storage unit 121 to store control information (cancel record) used by the server 110a to check whether the RPC process on the server-110b side has failed.

(A9) The RPC transmitting unit 113b of the server 110b transmits to the server 110a an RPC_ACK signal indicating that an RPC signal has been received normally. An RPC receiving unit 114a of the server 110a receives the RPC_ACK signal.

(A10) A requesting unit 112b of the server 110b sends to the DB server 120 an addition request for adding a transaction amount to data on the account B.

(A11) In response to the request, the processing unit 123 of the DB server 120 performs a process of adding the transaction amount to data on the account B.

(A12) A processing unit 115b of the server 110b commits the update of data on the account B.

(A13) The RPC transmitting unit 113b of the server 110b transmits to the server 110a a response signal that includes information indicating that processing invoked by an RPC signal has been finished normally. The response signal reports whether processing for an RPC signal received in (A5) has succeeded. The RPC receiving unit 114a of the server 110a receives the response signal.

(A14) A processing unit 115a of the server 110a commits update of data on the account A.

Through the processes of (A1)-(A14), after processing on the server-110b side, i.e., the destination of an RPC, is committed, the server 110a, i.e., the source of the RPC, commits processing thereof. This may achieve consistency between data on the account A at the source of the RPC and data on the account B at the destination of the RPC. After the transaction processing sequence is finished in (A14), the cancel record stored in the storage unit in (A8) is deleted.

For processing on the server-110b side, the following will describe distributed transaction processing with reference to a situation in which a fault has occurred. Note that the processes of (A1)-(A7) are performed before the process of (B1) is performed.

(B1) When processing fails in (A8) or (A9), the RPC transmitting unit 113b of the server 110b does not transmit to the server 110a an RPC_ACK signal indicating that an RPC signal has been received normally. The requesting unit 112b of the server 110b makes a request for the DB server 120 to roll back transaction processing related to the account B to the time of (A5), i.e., a time when an RPC signal is received. Upon receipt of the request for rollback, the DB server 120 regenerates the control information deleted in (A7), i.e., control information (check record) indicating that the RPC process on the server-110b side has not started. The DB server 120 stores control information and data on the account B as of (A5).

(B2) When the RPC receiving unit 114a of the server 110a receives a response signal that includes information indicating that processing invoked by an RPC signal has failed, the processing unit 115a of the server 110a determines that processing on the server-110a side has failed and that processing requested by the server 110b has been rolled back by the DB server 120.

(B3) When the RPC receiving unit 114a of the server 110a does not receive an RPC_ACK signal or response signal for a predetermined period of time, an obtaining unit 117a of the server 110a obtains control information from control information 122. When the controlling unit 111a of the server 110a obtains a check record despite the fact that an RPC process on the server-110b side has been performed, the controlling unit 111a determines that processing on the server-110b side has failed and that processing requested by the server 110b has been rolled back by the DB server 120. The regenerated check record is information indicating that processing requested by the server 110b has been rolled back by the DB server 120.

(B4) When processing requested by the server 110b is rolled back by the DB server 120, the requesting unit 112a of the server 110a makes a request for the DB server 120 to rollback transaction processing related to the account A to the time of (A1). The DB server 120 rolls back data on the account A to the time of (A1).

Through the process of (B2), the server 110a may detect, according to control information from the DB server 120, that processing requested by the server 110b has been rolled back. Accordingly, transaction processing requested by the server 110a is also rolled back on the server-110a side. In this way, data consistency is maintained between the accounts A and B in transaction processing. Unlike in the case of two-phase commit, data consistency is maintained between the accounts A and B without providing a management server for managing an addition process and a subtraction process.

For processing on the server-110b side, the following will describe another example of distributed transaction processing with reference to a situation in which a fault has occurred. Note that the processes of (A1)-(A7) are performed before the process of (C1) is performed. The processes of (B2)-(B4) are performed after the process of (C1) is performed.

(C1) When processing fails in (A10)-(A11), the RPC transmitting unit 113b of the server 110b does not transmit to the server 110a a response signal that includes information indicating that processing invoked by an RPC signal has been finished normally. The requesting unit 112b of the server 110b makes a request for the DB server 120 to roll back transaction processing related to the account B to the time of (A5), i.e., a time when an RPC signal is received. The DB server 120 stores control information and data on the account B as of (A5). Accordingly, the DB server 120 returns data on the account B to the data on the account B as of (A5). The DB server 120 regenerates the check record deleted in (A7). The RPC transmitting unit 113b of the server 110b may transmit to the server 110a a response signal that includes information indicating that processing invoked by the RPC signal has failed.

When the DB server 120 holds, as a processing object, information indicating that processing is a request process from the server 110a, i.e., the source of the RPC, the server 110a determines that processing requested by the server that is the destination of the RPC has been rolled back by the DB server 120. Then, the server 110a, i.e., the source of the RPC, makes a request for the DB server 120 to roll back the server 110a. When the server 110b, i.e., the destination of the RPC, commits processing, the server 110a, i.e., the source of the RPC, also commits processing. Hence, when rollback is performed at the destination of the RPC, the source server may perform rollback. In transaction processing, consistency is maintained between processing object data from the source of an RPC and processing object data of the destination of the RPC. Unlike in the case of two-phase commit, consistency is maintained between processing object data from the source of an RPC and processing object data of the destination of the RPC without providing a management server for managing processing of the source of the RPC and processing of the destination of the RPC.

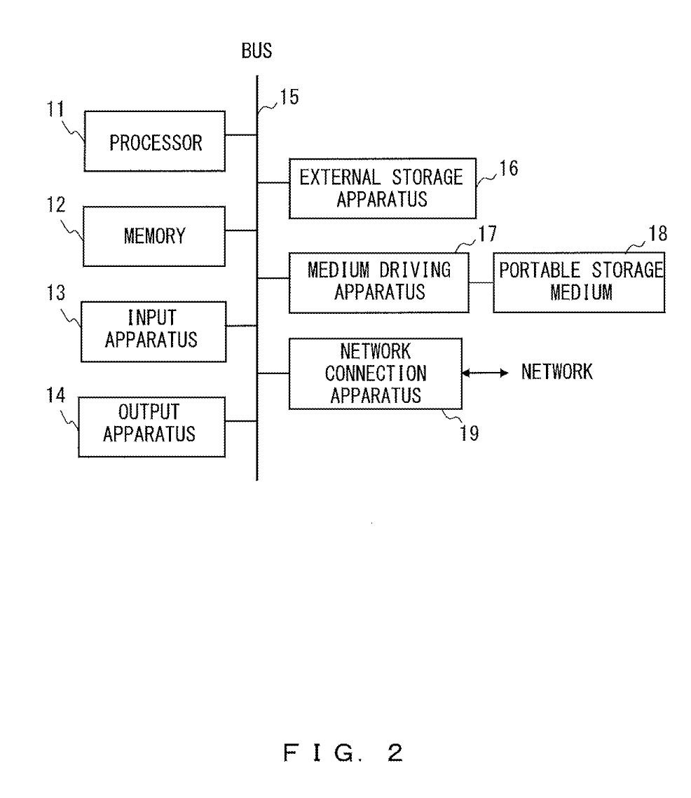

FIG. 2 illustrates an exemplary hardware configuration of a server or DB server. The server 110 and the DB server 120 include a processor 11, a memory 12, a bus 15, an external storage apparatus 16, and a network connection apparatus 19. In addition, the server 110 and the DB server 120 may optionally include an input apparatus 13, an output apparatus 14, and a medium driving apparatus 17. The server 110 and the DB server 120 may be achieved by, for example, a computer.

The processor 11 may be an arbitrary processing circuit that includes a Central Processing Unit (CPU). The processor 11 is operated as the controlling unit 111, the requesting unit 112, the RPC transmitting unit 113, the RPC receiving unit 114, and the processing unit 115, i.e., elements included in the server 110. The processor 11 is operated as the processing unit 124 included in the DB server 120. The processor 11 may execute a program stored in, for example, the external storage apparatus 16. The memory 12 is operated as the storage unit 116 included in the server 110. The memory 12 is operated as the storage unit 124 included in the DB server 120, and holds the database 123 and control information 122. In addition, the memory 12 also properly stores data obtained from an operation of the processor 11 and data to be used for processing performed by the processor 11. The network connection apparatus 19 is used for a communication with another apparatus.

The input apparatus 13 is achieved as, for example, a button, keyboard, or mouse. The output apparatus 14 is achieved as a display or the like. The bus 15 connects the processor 11, the memory 12, the input apparatus 13, the output apparatus 14, the external storage apparatus 16, the medium driving apparatus 17, and the network connection apparatus 19 to each other so that data can be exchanged therebetween. The external storage apparatus 16 stores a program, data, and so on and properly provides stored information to the processor 11 or the like. The medium driving apparatus 17 may output data from the memory 12 and the external storage apparatus 16 to a portable storage medium 18, and may read a program, data, and so on from the portable storage medium 18. The portable storage medium 18 may be an arbitrary storage medium that can be carried, e.g., a floppy disk, Magnet-Optical (MO) disk, Compact Disc Recordable (CD-R), or Digital Versatile Disk Recordable (DVD-R)).

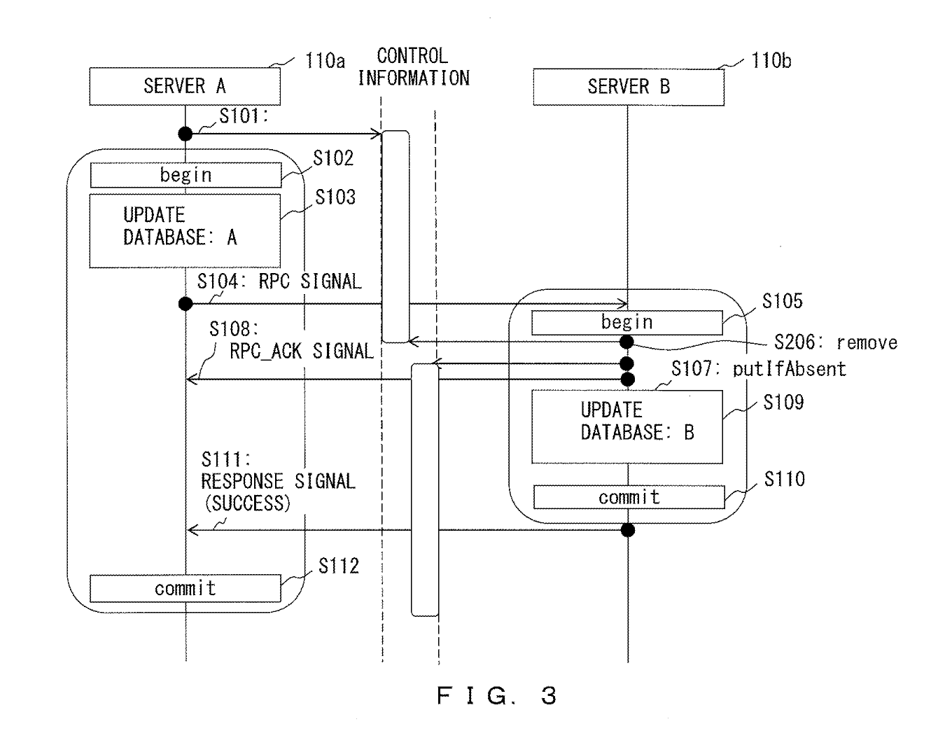

FIG. 3 is a sequence diagram illustrating an example of distributed transaction processing performed when a fault has not occurred. The server 110a reports to the DB server 120 a primitive (putIfAbsent) intended for data on the account A. The DB server 120 stores, in the storage unit 121, control information (check record) indicating that an RPC process on the server-110b side has not started (step S101). The server 110a starts transaction processing for updating data on the account A. Execution of rollback in transaction processing invalidates all of the processes performed at and after a time indicated by “begin” (step S102). The DB server 120 stores data on, and control information of, the account A as of the time indicated by “begin”. The server 110a sends to the DB server 120 a subtraction request for subtracting a transaction amount from data on the account A. In response to the request, the DB server 120 performs a process of subtracting the transaction amount from data on the account A (step S103). The server 110a transmits an RPC signal to the server 110b (step S104).

Upon receipt of the RPC signal, the server 110b starts transaction processing. In transaction processing, a request for rollback from the server 110b invalidates all of the processes performed at and after the time indicated by “begin” (step 105). The server 110b reports a primitive (remove) to the DB server 120. The DB server 120 deletes a check record from control information 122 (step S106). The server 110b reports to the DB server 120 a primitive (putIfAbsent) intended for data on the account B. The DB server 120 stores, in the storage unit 121, control information (cancel record) to be used by the server 110a to check whether the RPC process on the server-110b side has failed (step S107). The server 110b transmits an RPC_ACK signal to the server 110a (step S108). The server 110b sends to the DB server 120 an addition request for adding a transaction amount to data on the account B. In response to the request, the DB server 120 performs a process of adding the transaction amount to data on the account B (step S109). The server 110b commits data on the account B after update (step S110). The server 110b transmits to the server 110a a response signal that includes information indicating that processing invoked by the RPC signal has been finished normally (step S111). The server 110a commits data on the account A after update (step S112). Through S101-S112, distributed transaction processing for transferring money from the account A to the account B is completed. After distributed transaction processing is finished, the cancel record stored in the storage unit 121 in S107 is deleted.

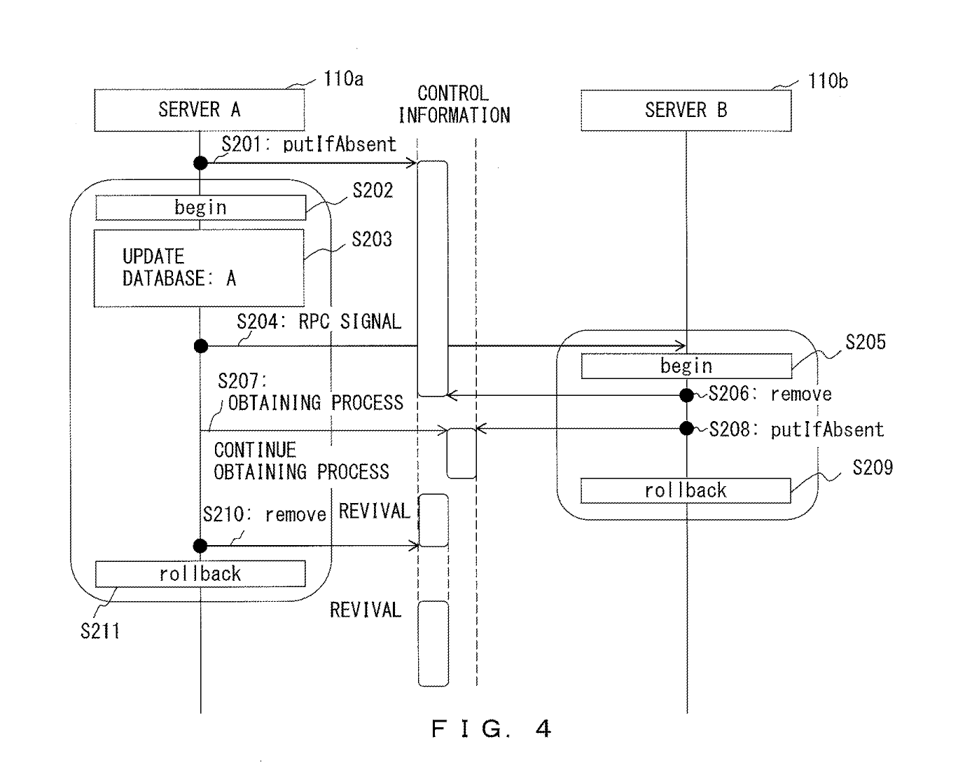

FIG. 4 is a sequence diagram illustrating an exemplary process performed in a system when handshaking fails (example 1). Handshaking is a process of checking whether an RPC signal has been transmitted or received normally between the servers 110a and 110b. In one possible example, the facts that the server 110b has received the RPC signal in S104 of FIG. 3 and that the server 110a has received the RPC_ACK signal in S108, i.e., a signal indicating whether the RPC signal has been received normally, mean that handshaking has succeeded. The processes of S201-S206 in FIG. 4 are the same as the processes of S101-S106 in FIG. 3, and hence descriptions thereof are omitted herein.

The server 110a cannot receive an RPC_ACK signal. Hence, when a predetermined period of time has elapsed since the transmission of the RPC signal in S204, the server 110a checks control information so as to recognize the status of processing performed by the server 110b. The server 110a obtains a check record and a cancel record from the DB server 120 (step S207). The server 110b reports to the DB server 120 a primitive (putIfAbsent) intended for data on the account B. The DB server 120 stores, in the storage unit 121, control information (cancel record) to be used by the server 110a to check whether the RPC process on the server-110b side has failed (step S208). The server 110b has failed in the processing after S208 and thus makes a request for the DB server 120 to roll back processing that has started on the server-110b side to the time of S205 (step S209). In the process of S209, the server 110b makes a request for the DB server 120 to invalidate the information stored in the storage unit 121 in S208. In addition, the server 110b makes a request for the DB server 120 to regenerate the control information (check record) deleted in S206, i.e., control information indicating that the RPC process on the server-110b side has not started. The DB server 120 performs a requested rollback process.

The server 110a repeats the process of S207, i.e., a process of obtaining control information, for a predetermined time period since the start of S207. As a result, the server 110a detects that control information (check record) indicating that the RPC process on the server-110b side has not started has been regenerated in control information 122. The server 110a reports a primitive (remove) intended for a check record to the DB server 120. The DB server 120 deletes, from control information 122, control information (check record) indicating that the RPC process on the server-110b side has not started. The server 110a makes a request for the DB server 120 to roll back processing that has started on the server-110a side to the time of S202 (step S211). In the rollback in S211, the server 110a transmits to the DB server 120 a request to change data on the account A back into a state before the process of S203. The DB server 120 performs processing that depends on the request from the server 110a, and changes data on the account A back into the state before the process of S203. At the time of S202, the DB server 120 has stored therein control information (check record) indicating that the RPC process on the server-11b side has not started, and hence, in the rollback in S211, the DB server 120 regenerates the check record.

By repeating the obtaining process of S207, the server 110a may detect that the check record has been regenerated. The server 110a detects that the server 110b has performed rollback from the fact that the check record has been regenerated. Thus, in addition to the rollback process on the server-110b side, the data updating process performed on the account A by the server 110a is also rolled back. This maintains consistency between the accounts A and B.

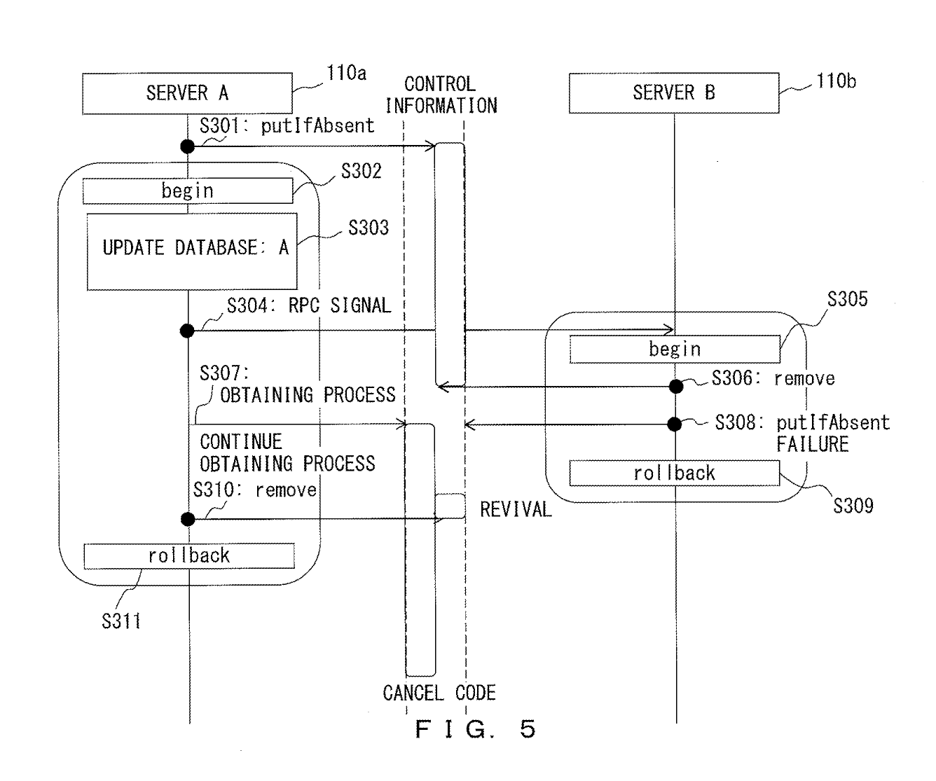

FIG. 5 is a sequence diagram illustrating an exemplary process performed in a system when handshaking fails (example 2). FIG. 5 depicts an exemplary operation of the system modified in a manner such that information on an error that is a cause of rollback is not deleted in the rollback. The processes of S301-S306 in FIG. 5 are the same as the processes of S101-S106 in FIG. 3, and hence descriptions thereof are omitted herein.

After the RPC signal transmitting process in S304 is performed, the server 110a periodically obtains control information indicating the states of the accounts A and B from the DB server 120 (step S307). A primitive (putIfAbsent) process invoked by the server 110b to the DB server 120 fails. The DB server 120 stores, in the storage unit 121, control information indicating that the generating of a cancel record has failed (step S308). The server 110b makes a request for the DB server 120 to roll back processing that has started on the server-110b side to the time of S305 (step S309). In the rollback of S309, the DB server 120 invalidates the deleting process for a check record performed in S306 and regenerates the check record. In the rollback of S309, the DB server 120 does not delete the control information of S308, i.e., control information indicating that the generating of a cancel record has failed. This enables the administrator of the system to recognize that the generating of a cancel record has failed in the process of S308.

In the obtaining process for control information in S307, processing is performed for a predetermined time period since the start of the process of S307. As a result, the server 110a detects that control information (check record) indicating that an RPC process on the server-110b side has not started is present in control information 122. The server 110a reports a primitive (remove) intended for the check record to the DB server 120. The DB server 120 deletes the check record from control information 122 (step S310). The server 110a makes a request for the DB server 120 to roll back processing that has started on the server-110a side to the time of S302 (step S311). In the rollback in S311, the server 110a transmits to the DB server 120 a request to change data on the account A back into the state before the process of S303. The DB server 120 performs processing that depends on the request from the server 110a, and changes data on the account Aback into the state before the process of S303. In the rollback in S311, the DB server 120 does not regenerate the check record stored at the time of S302. When control information indicating that the generating of a cancel record has failed is stored in the storage unit 121, the DB server 120 decides to not regenerate the check record.

By repeating the obtaining process of S307, the server 110a may detect that the check record has been regenerated. The server 110a detects that processing on the server-110b side has been rolled back from the fact that the check record has been regenerated. In addition to the rollback on the server-110b side, the data updating process performed on the account A by the server 110a is also rolled back. This maintains consistency between the accounts A and B. In the transaction processing in FIG. 5, after the processing is finished, the administrator may check control information so as to recognize that the updating of control information performed in S308, i.e., control information related to the account B, has failed.

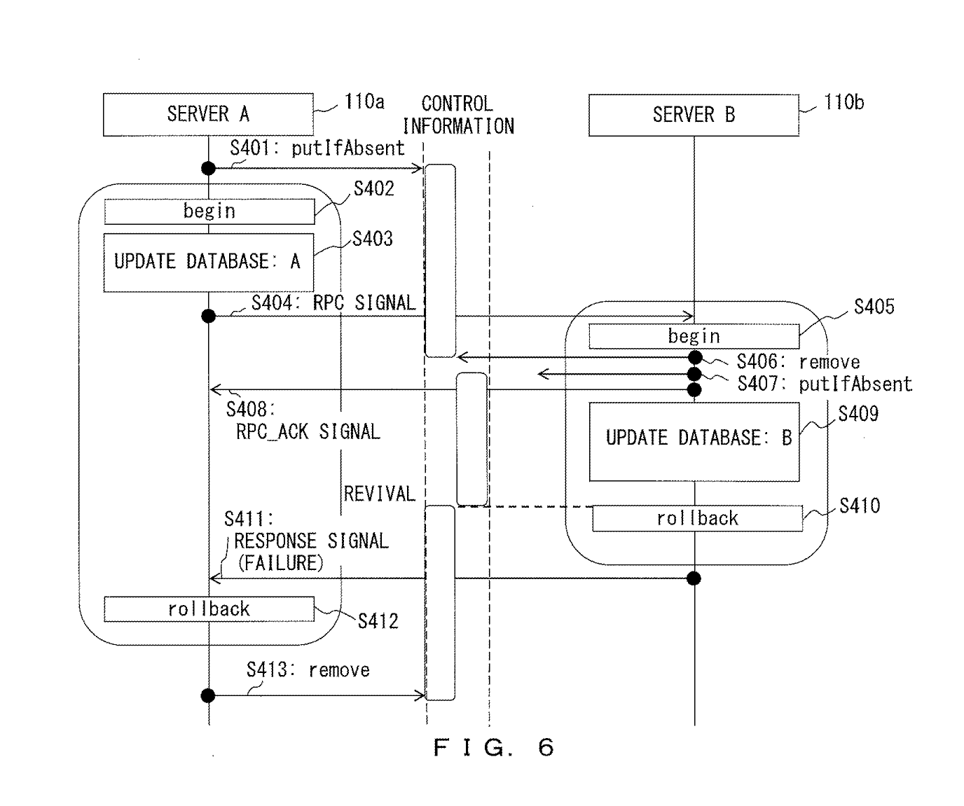

FIG. 6 is a sequence diagram illustrating an exemplary situation in which a response signal is transmitted that indicates that transaction processing has failed. The processes of S401-S409 in FIG. 5 are the same as S101-S109 in FIG. 3, and hence descriptions thereof are omitted herein.

Due to a fault that has occurred in the server 110b after the process of S409 is performed, the server 110b makes a request for the DB server 120 to roll back processing that has started on the server-110b side to the time of S405 (step S410). In the rollback in S410, the server 110b transmits to the DB server 120 a request to change data on the account B back into the state before the process of S409. The DB server 120 performs processing that depends on the request from the server 110b, and changes data on the account B back into the state before the process of S409. In the process of S410, the DB server 120 invalidates information stored in the storage unit 121 in 5407. In addition, in the process of S410, the DB server 120 regenerates the check record.

The server 110b transmits to the server 110a a response signal that includes information indicating that processing invoked by an RPC signal has failed (step S411). The server 110a makes a request for the DB server 120 to roll back processing that has started on the server-110a side to the time of S402 (step S412). In the rollback in S412, the server 110a transmits to the DB server 120 a request to change data on the account A back into the state before the process of S403. The DB server 120 performs processing that depends on the request from the server 110a, and changes data on the account Aback into the state before the process of S403. At the time of S412, the DB server 120 has a check record stored therein, and hence the DB server 120 does not perform a regenerating process. The server 110a reports a primitive (remove) intended for the check record to the DB server 120. The DB server 120 deletes the check record from control information 122 (step S413).

Upon receipt of the response signal of S411, i.e., a response signal that includes information indicating that processing invoked by an RPC signal has failed, the server 110a performs a process of obtaining control information. The process of obtaining control information enables the detection of the fact that the control information (check record) indicating that an RPC process on the server-110b side has not started has been regenerated, and the detection of the fact that the server 110b has performed rollback. In this way, in conformity with the rollback on the server-110b side, the data updating process performed on the account A by the server 110a is rolled back, thereby maintaining consistency between the accounts A and B.

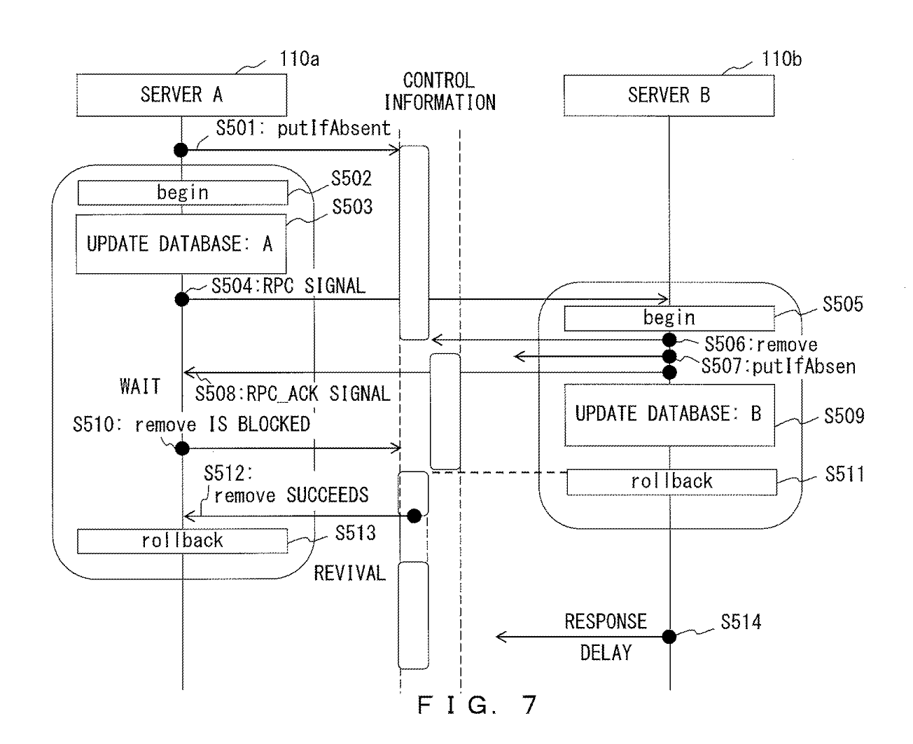

FIG. 7 is a sequence diagram illustrating an example of transaction processing performed when a response signal is delayed (example 1). The sequence diagram of FIG. 7 depicts an exemplary situation in which the response signal (S411) of FIG. 5 has been delayed. The processes of S501-S509 in FIG. 7 are the same as S101-S109 in FIG. 3, and hence descriptions thereof are omitted herein.

When a response signal is not received for a predetermined time period since the reception of an RPC_ACK signal in S508, the server 110a reports a primitive (remove) intended for a check record to the DB server 120. Using the primitive (remove), the server 110a may determine that the check record has been regenerated, and may determine whether processing on the server-110b side has been rolled back. However, the DB server 120 does not have a check record stored in the storage unit 121, and hence processing for the primitive (remove) is not performed (step S510). Due to a fault that has occurred in the server 110b after the process of S509 is performed, the server 110b makes a request for the DB server 120 to roll back processing that has started on the server-110b side to the time of S505 (step S511). In the rollback in S511, the server 110b transmits to the DB server 120 a request to change data on the account B back into the state before the process of S509. The DB server 120 performs processing that depends on the request from the server 110a, and changes data on the account B back into the state before the process of S509. In the process of S511, the DB server 120 invalidates information stored in the storage unit 121 in 5507. In addition, in the process of S511, the DB server 120 regenerates the check record.

The regenerating of the check record in the rollback in S511 allows processing for the primitive (remove) received by the DB server 120 in 5510 to be performed. The DB server 120 deletes the check record from control information 122 and reports to the server 110a that the check record has been successfully deleted (step S512). The server 110a makes a request for the DB server 120 to roll back processing that has started on the server 110a to the time of S502 (step S513). In the rollback in S513, the server 110a transmits to the DB server 120 a request to change data on the account Aback into the state before the process of S503. The DB server 120 performs processing that depends on the request from the server 110a, and changes data on the account A back into the state before the process of S503. In the rollback in S513, the DB server 120 regenerates the check record. Then, the server 110b transmits to the server 110a a response signal that includes information indicating that processing invoked by an RPC signal has failed (step S514).

In the system of FIG. 7, upon receipt of information indicating that the processing for the primitive (remove) in S512 has succeeded, the server 110a may detect that the control information (check record) indicating that an RPC process on the server-110b side has not started has been regenerated. In addition, in accordance with the regeneration of the check record, the fact that processing that has started on the server-110b side has been rolled back may be detected. In this way, in conformity with the rollback of processing that has started on the server-110b side, the data updating process performed on the account A by the server 110a is rolled back, thereby maintaining consistency between the accounts A and B.

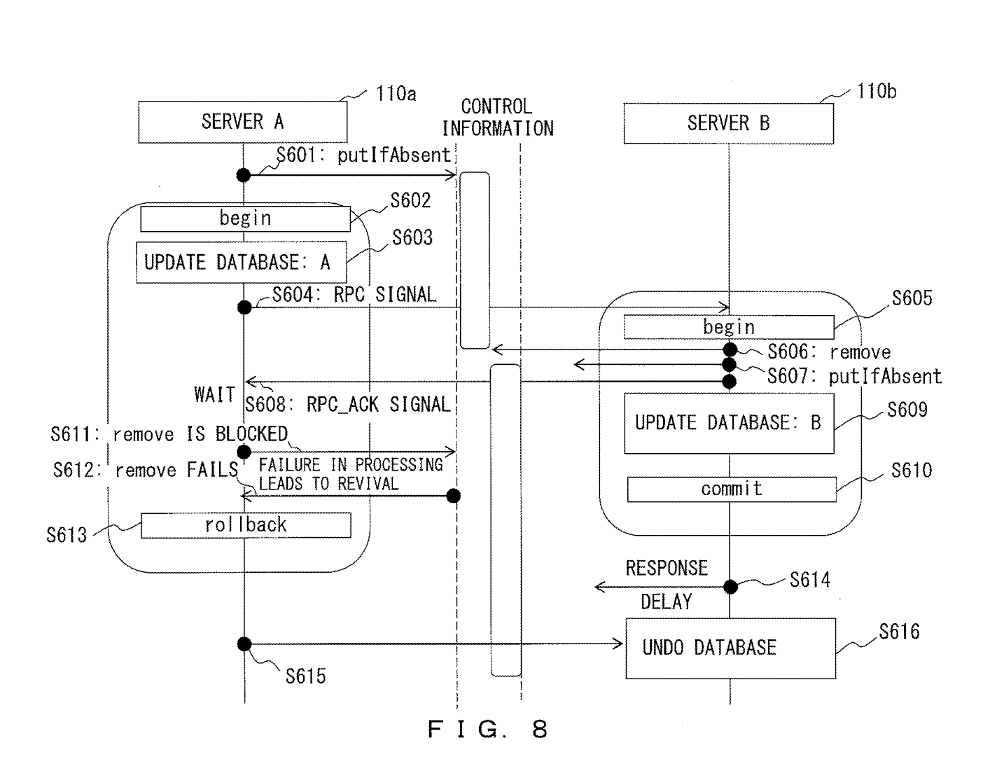

FIG. 8 is a sequence diagram illustrating an example of transaction processing performed when a response signal is delayed (example 2). The sequence diagram of FIG. 8 depicts an exemplary situation in which a response signal has been delayed despite the fact that updated data of the server 110b has been committed. The processes of S601-S610 in FIG. 8 are the same as S101-S110 in FIG. 3, and hence descriptions thereof are omitted herein.

In S610, the updating process performed on the account B by the server 110b is committed. However, in a case where a response signal that includes information indicating that processing invoked by an RPC signal in S112 in FIG. 1 has succeeded is delayed and is not received for a predetermined time period, the server 110a performs the processes of S611 and the following steps. When a response signal is not received for a predetermined time period, the server 110a reports a primitive (remove) intended for a check record to the DB server 120. However, the DB server 120 does not have a check record stored in the storage unit 121, and hence processing for the primitive (remove) is not performed (step S611). The updating process performed on the account B by the server 110b is committed in S610, and hence the check record is not regenerated. Thus, control information that is a target of the primitive (remove) is not present for a predetermined time period, and this results in a failure of the primitive (remove) process (step S612). The server 110a makes a request for the DB server 120 to roll back processing that has started on the server-110a side to the time of S602 (step S613). In the rollback in S613, the server 110a transmits to the DB server 120 a request to change data on the account Aback into the state before the process of S603. The DB server 120 performs processing that depends on the request from the server 110a, and changes data on the account A back into the state before the process of S603. In the rollback in S613, the DB server 120 does not regenerate the check record.

Subsequently, the server 110b transmits to the server 110a a response signal (delay) that includes information indicating that processing invoked by an RPC signal has succeeded (step S614). However, since the rollback process has already been performed on processing on the server-110a side, a request is made for the server 110b to perform an invalidating process on the database (step S615). The server 110b invalidates the updating process performed on the database in S609 (step S616). The sequence diagram of FIG. 8 depicts an exemplary situation in which processing on the server-110b side has been rolled back despite the fact that processing on the server-110b side has been committed. Accordingly, the server 110a invalidates the committed processing on the server-110a side. In this way, in conformity with the rollback on the server-110a side, the data updating process performed on the account B by the server 110b is rolled back, thereby maintaining consistency between the accounts A and B.

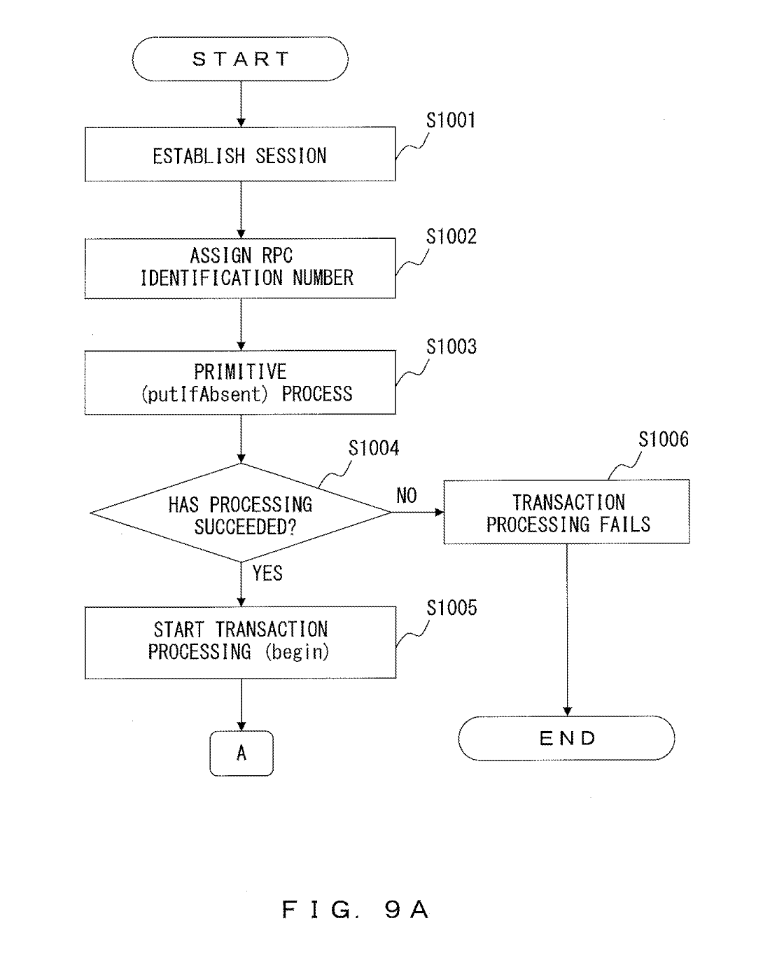

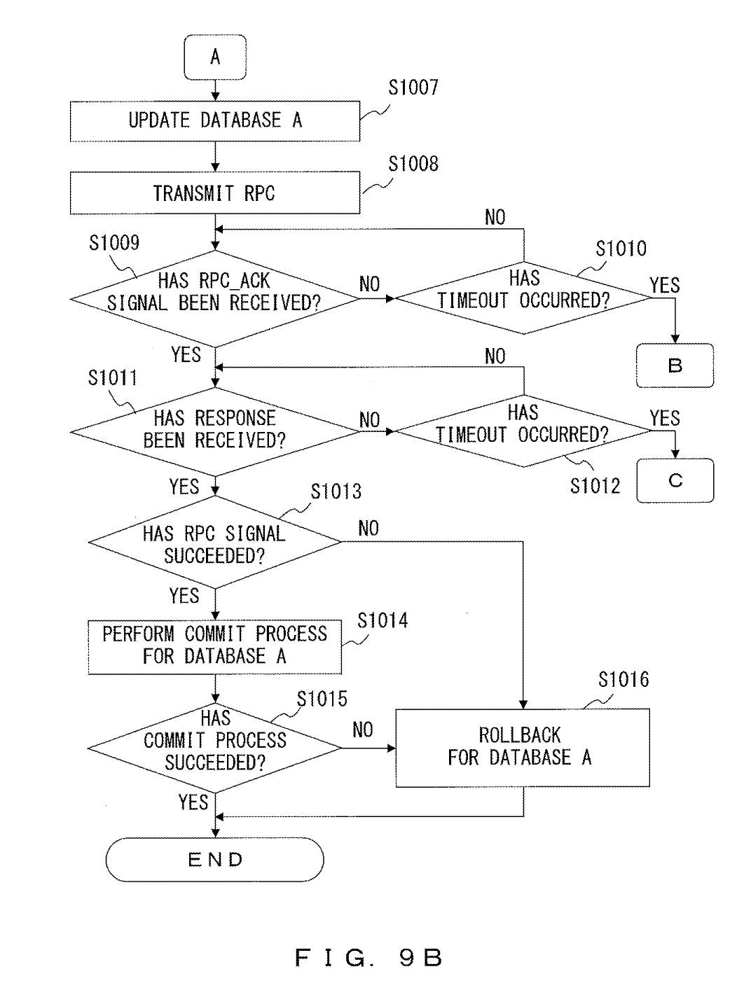

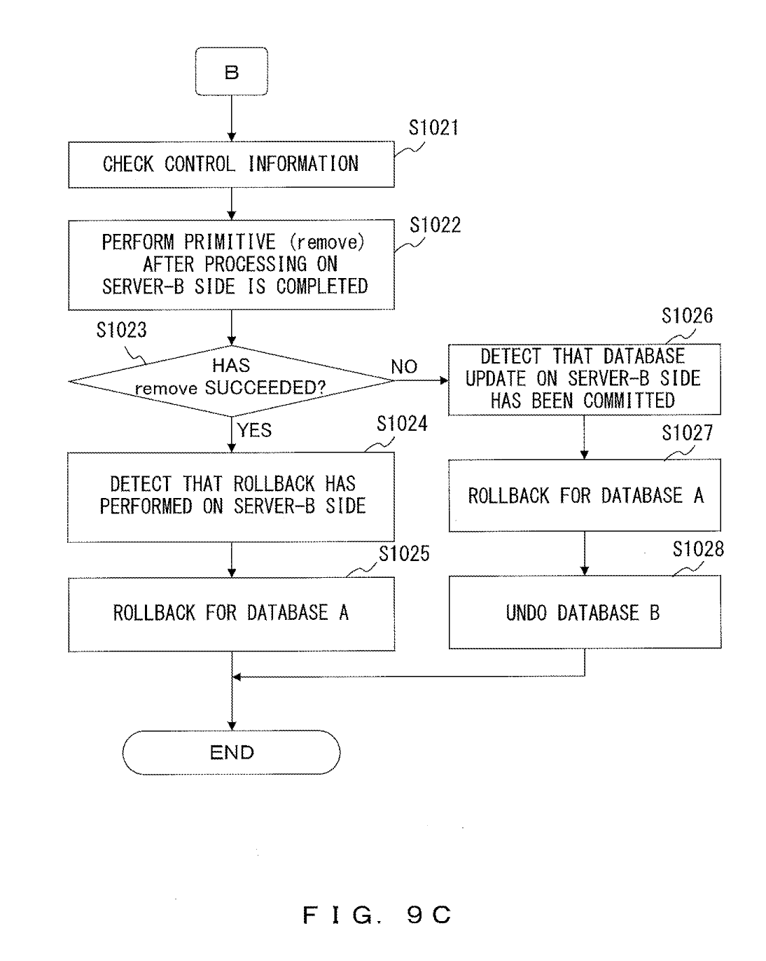

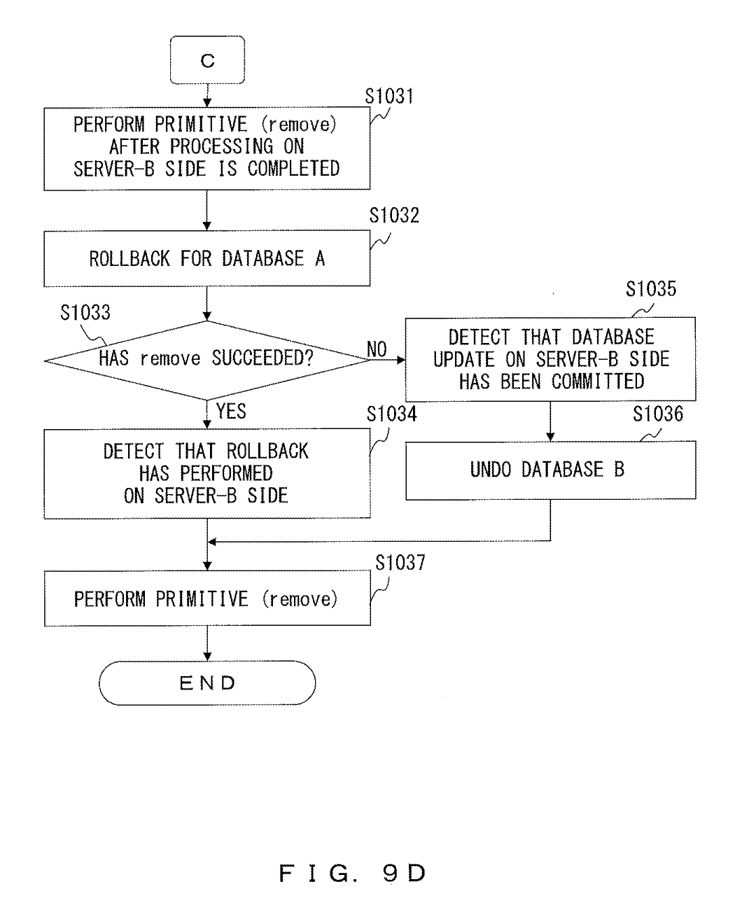

FIGS. 9A-9D are flowcharts illustrating an example of transaction processing performed on the server-A side in accordance with an embodiment. The transaction processing will be described with reference to a sequence of indivisible processes of addition and subtraction for transfer of money from the account A to the account B.

FIG. 9A is a flowchart illustrating an example of transaction processing performed on the server-A side. The processing unit 115 of the server 110a secures a communication path to the server 110b (step S1001). The processing unit 115 of the server 110a assigns an identification number to an RPC of transaction processing to be performed (step S1002). The controlling unit 111a of the server 110a reports to the DB server 120 a primitive (putIfAbsent) that is an instruction to write control information (check record) indicating that an RPC process on the server-11b side has not started (step S1003). The processing unit 115 of the server 110a determines whether the instruction to write the check record has been processed normally on the DB-server-120 side (step S1004). When the instruction is processed normally, the check record is stored in the storage unit 121 of the DB server 120. The processing unit 115 of the server 110a starts (begin) transaction processing (step S1005; YES in step S1004).

FIG. 9B is a flowchart illustrating an example of processing after S1005 in FIG. 9A. When an instruction to write a check record is not processed normally on the DB-server-120 side, the check record is not stored in the storage unit 121 of the DB server 120. The processing unit 115 of the server 110a ends transaction processing (step S1006; NO in step S1004). The requesting unit 112a of the server 110a sends to the DB server 120 a subtraction request for subtracting a transaction amount from data on the account A (step S1007). In response to the request, the processing unit 123 of the DB server 120 performs a process of subtracting the transaction amount from data on the account A. Before committing data on the account A, the RPC transmitting unit 113a of the server 110a transmits an RPC signal to the server 110b, i.e., a server that updates data on the account B (step S1008). In a money transfer from the account A to the account B, the subtraction process performed on the account A and the addition process performed on the account B are performed as a sequence of indivisible processes. An RPC signal serves as a request to start an addition process that has not been performed.

The processing unit 115 of the server 110a determines whether the RPC receiving unit 114a has received an RPC_ACK signal indicating that the server 110b has received the RPC signal normally (step S1009). The processing unit 115 of the server 110a determines whether a predetermined time period has elapsed since the transmission of the RPC signal (step S1010; NO in step S1009). When it is determined in S1010 that the predetermined time period has elapsed, the server 110a shifts the flow to S1021. When it is determined in S1010 that the predetermined time period has not elapsed, the server 110a repeats the process of S1009.

The processing unit 115 of the server 110a determines whether the RPC receiving unit 114a has received a response signal that includes result information indicating whether the processing on the server-110b side invoked by the RPC signal transmitted in S1008 has been processed normally (step S1011; YES in step S1009). The processing unit 115 of the server 110a determines whether a predetermined time period has elapsed since the transmission of the RPC signal (step S1012; NO in step S1011). When it is determined in S1012 that the predetermined time period has elapsed, the server 110a shifts the flow to S1031. When it is determined in S1012 that the predetermined time period has not elapsed, the server 110a repeats the process of S1011.

The processing unit 115a of the server 110a determines whether success is indicated by a result included in a received response signal and indicating whether the processing on the server-110b side invoked by an RPC signal has been processed normally (step S1003; YES in step S1011). The processing unit 115a of the server 110a commits update of data on the account A processed in S1007 (step S1014; YES in step S1013). The processing unit 115a of the server 110a determines whether the commit process performed in S1014 has succeeded (step S1015). The server 110a makes a request for the DB server 120 to roll back processing performed in and after S1005 (step S1016; NO in step S1013; NO in step S1015). The processing unit 115a of the server 110a ends transaction processing (YES in step S1015).

FIG. 9C is a flowchart illustrating an example of processing performed when a judgement of YES is indicated in S1010 in FIG. 9B. The obtaining unit 117a of the server 110a periodically obtains control information 122 (step S1021). After processing on the server-110b side is completed, the controlling unit 111a of the server 110a reports a primitive (remove) intended for a cancel record to the DB server 120 (step S1022). The processing unit 115a of the server 110a determines whether processing of the primitive (remove) intended for the cancel record has been performed (step S1023). The processing unit 115a of the server 110a detects that transaction processing on the server-110b side has been rolled back (step S1024; YES in step S1023). The server 110a makes a request for the DB server 120 to roll back processing performed in and after S1005 (step S1025). The processing unit 115a of the server 110a determines that the database update on the server-110b side has been committed (step S1026; NO in step S1023). The server 110a makes a request for the DB server 120 to roll back processing performed in and after S1005 (step S1027). The processing unit 115a of the server 110a makes a request to invalidate the updating process on data on the account B updated in a procedure invoked by the RPC signal of S1008 (step S1028).

FIG. 9D is a flowchart illustrating an example of processing performed when a judgement of YES is indicated in S1012 in FIG. 9B. After processing on the server-110b side is completed, the controlling unit 111a of the server 110a reports a primitive (remove) intended for a cancel record to the DB server 120 (step S1031). The server 110a makes a request for the DB server 120 to roll back processing performed in and after S1005 (step S1032). The processing unit 115a of the server 110a determines whether processing of the primitive (remove) intended for the cancel record has been performed (step S1033). The processing unit 115a of the server 110a detects that transaction processing on the server-110b side has been rolled back (step S1024; YES in step S1023). The processing unit 115a of the server 110a determines that the database update on the server-110b side has been committed (step S1035; NO in step S1033). The processing unit 115a of the server 110a makes a request to invalidate the updating process on data on the account B updated in the procedure invoked by the RPC signal of S1008 (step S1036). After processing on the server-110b side is completed, the controlling unit 111a of the server 110a reports a primitive (remove) intended for a cancel record to the DB server 120 (step S1037; after the process of step S1306).

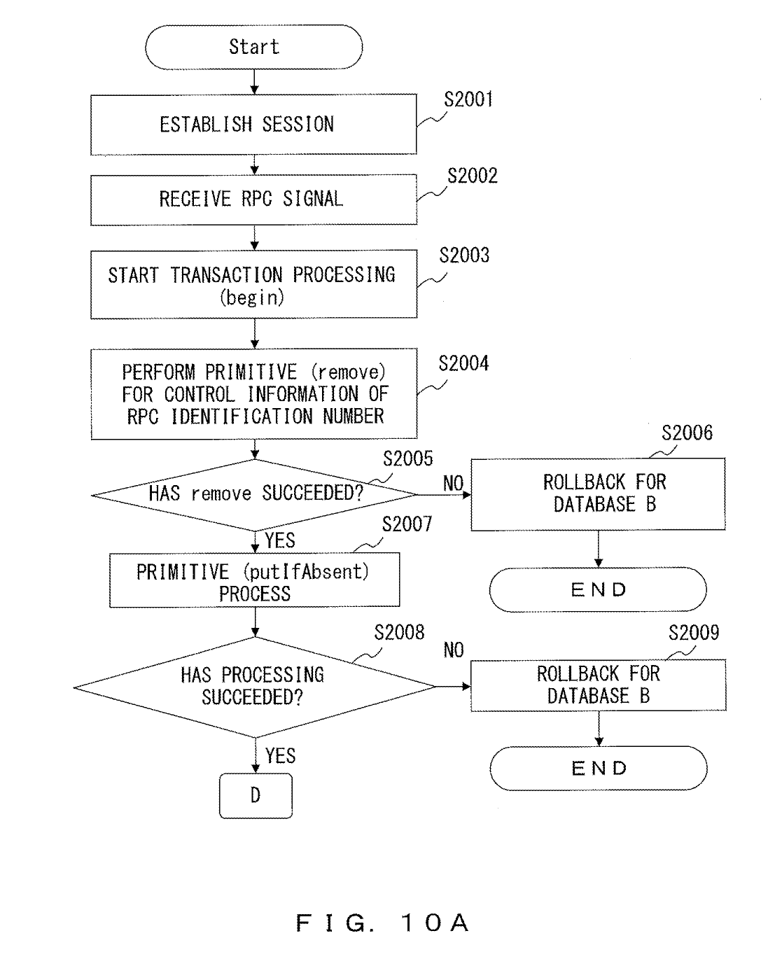

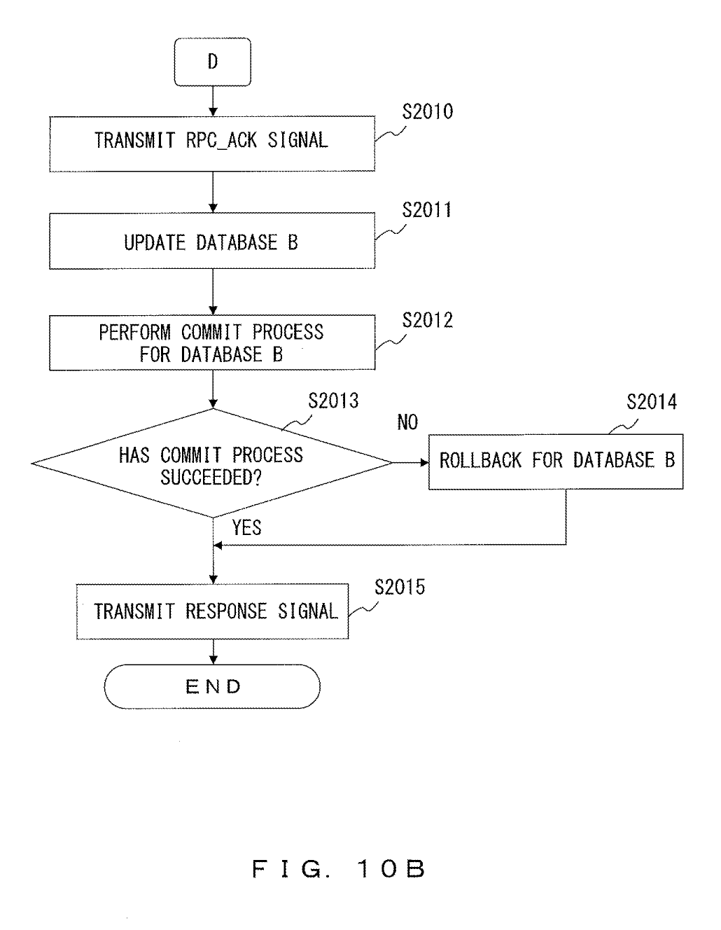

FIGS. 10A-10B are flowcharts illustrating an example of transaction processing performed on the server-B side in accordance with an embodiment. The transaction processing will be described with reference to a sequence of indivisible processes of addition and subtraction for transfer of money from the account A to the account B.

The processing unit 115b of the server 110b approves a request to secure a communication path from the server 110a (step S2001). An RPC receiving unit 114b of the server 110b receives from the server 110a an RPC signal that includes a request to update the account B (step S2002). The processing unit 115b of the server 110b starts (begin) transaction processing (step S2003). The controlling unit 111b of the server 110b reports a primitive (remove) intended for a check record to the DB server 120 (step S2004). The check record of S2004 is recognized using an RPC identification number included in the RPC signal received in S2002. The processing unit 115b of the server 110b determines whether processing of the primitive (remove) intended for the check record has been performed (step S2005). The processing unit 115b of the server 110b makes a request for the DB server 120 to roll back processing performed in and after S2003 (step S2006; NO in step S2005). The controlling unit 111b of the server 110b reports to the DB server 120 a primitive (PutIfAbsent) that is an instruction to write control information (cancel record) to be used by the server 110a to check whether the RPC process on the server-110b side has failed (step S2007). The processing unit 115b of the server 110b determines whether the instruction to write the cancel record has been processed normally on the DB-server-120 side (step S2008). The processing unit 115b of the server 110b makes a request for the DB server 120 to roll back processing performed in and after S2003 (step S2009; NO in step S2008). After the processes of S2006 and S2009, the transaction processing on the server-110b side ends.

FIG. 10B is a flowchart illustrating processing performed after S2008. The RPC transmitting unit 113b of the server 110b transmits an RPC_ACK signal to the server 110a (step S2010). The requesting unit 112b of the server 110b sends to the DB server 120 an addition request for adding a transaction amount to data on the account B (step S2011). The processing unit 115b of the server 110b commits the data on the account B after the addition process (step S2012). The processing unit 115b of the server 110b determines whether the committing process has succeeded (step S2013). The processing unit 115b of the server 110b makes a request for the DB server 120 to roll back processing performed in and after S2003 (step S2014; NO in step S2013). The RPC transmitting unit 113b of the server 110b transmits to the server 110a a response signal that includes information indicating whether processing performed after the RPC signal is received in S2002 has succeeded (step S2015; YES in step S2013).

When the DB server 120 holds, as a processing object, information indicating that processing is a request process from the server 110a, i.e., the source of the RPC, the server 110a determines that processing requested by the server that is the destination of the RPC has been rolled back by the DB server 120. Then, the server 110a, i.e., the source of the RPC, makes a request for the DB server 120 to roll back the server 110a. When the server 110b, i.e., the destination of the RPC, commits processing, the server 110a, i.e., the source of the RPC, also commits processing. Hence, when rollback is performed at the destination of the RPC, the source server may perform rollback. In transaction processing, consistency is maintained between processing object data from the source of an RPC and processing object data of the destination of the RPC. Unlike in the case of two-phase commit, consistency is maintained between processing object data from the source of an RPC and processing object data of the destination of the RPC without providing a management server for managing processing of the source of the RPC and processing of the destination of the RPC.

### Other Embodiments

Embodiments are not limited to those described above, and various variations are possible. The following will describe examples of such variations.

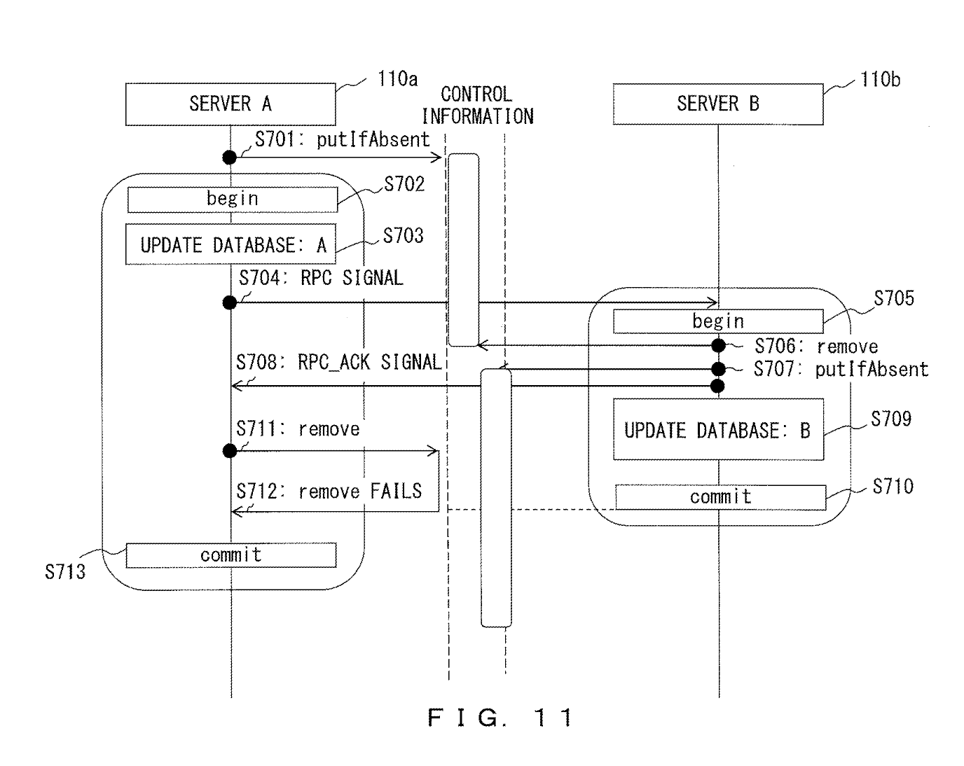

FIG. 11 is a sequence diagram illustrating an example of distributed transaction processing wherein a response signal corresponding to an RPC signal is not used (example 1). The same system configuration as that in FIG. 1 may be used for the distributed transaction processing in FIG. 11. The processes of S701-S710 in FIG. 11 are the same as the processes of S101-S110 in FIG. 3, and hence descriptions thereof are omitted herein.

When a predetermined time period has elapsed since the process of S708, the server 110a reports a primitive (remove) intended for a check record to the DB server 120. However, processing for the primitive (remove) is not performed (step S711) because control information (check record) indicating that an RPC process on the server-110b side has not started is not stored in the storage unit 121 of the DB server 120. A check record for which the primitive (remove) is intended is not present even when a predetermined time period has elapsed since the process of S711, and hence the primitive (remove) process fails (step S712). When control information (check record) indicating that an RPC process on the server-110b side has not started is not stored in the storage unit 121, the server 110a determines that the transaction processing on the server-110b side has been finished normally. The server 110a commits the data on the account A after update (step S713).

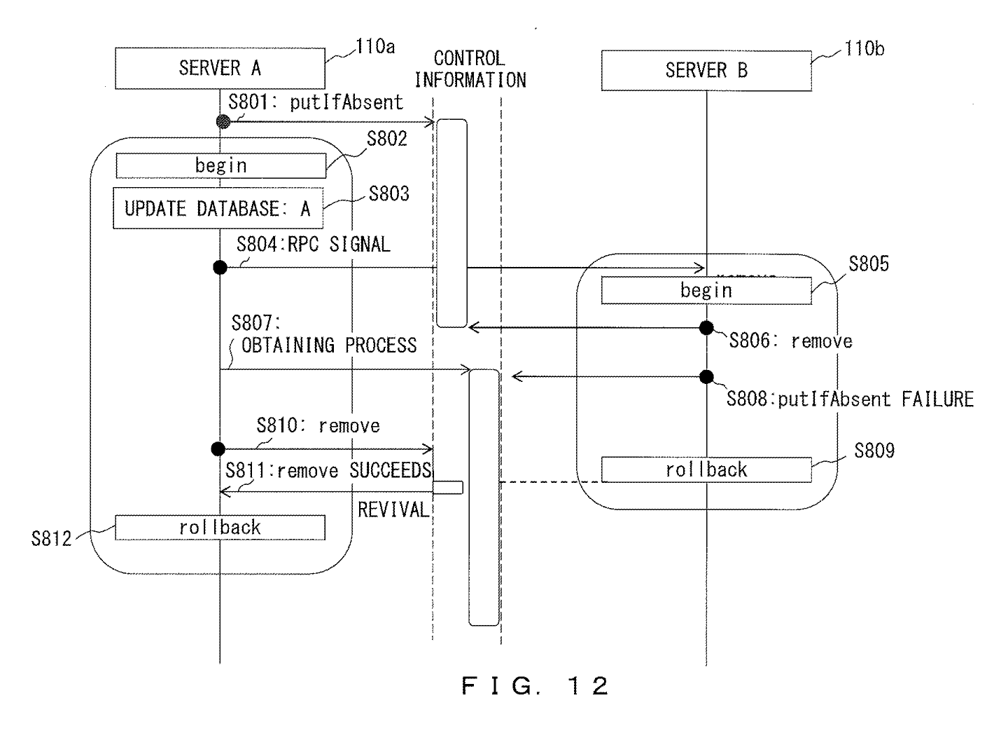

FIG. 12 is a sequence diagram illustrating an example of distributed transaction processing wherein a response signal corresponding to an RPC signal is not used (example 2). The sequence diagram of FIG. 12 depicts an example of transaction processing for a situation in which handshaking has failed due to a failure in a primitive (putIfAbsent) process. The processes of S801-S806 in FIG. 12 are the same as the processes of S701-S706 in FIG. 11, and hence descriptions thereof are omitted herein.

After the RPC signal transmitting process in S804 is performed, the server 110a periodically obtains control information from the DB server 120 (step S807). A primitive (putIfAbsent) process invoked by the server 110b to the DB server 120 fails. The DB server 120 stores, in the storage unit 121, control information indicating that the generating of a cancel record has failed (step S808). The server 110b makes a request for the DB server 120 to roll back processing that has started on the server-110b side to the time of S805 (step S809). In the rollback of S809, the DB server 120 invalidates the deleting process for a check record performed in S806 and regenerates the check record. In the rollback of S809, the DB server 120 does not delete the control information of S808, i.e., control information indicating that the generating of a cancel record has failed. This enables the administrator of the system to recognize that the generating of a cancel record has failed in the process of S808.

When a predetermined time period has elapsed since the process of S807, the server 110a reports a primitive (remove) intended for a check record to the DB server 120. However, the DB server 120 does not have a check record stored in the storage unit 121, and hence processing for the primitive (remove) is not performed (step S810). In the sequence diagram of FIG. 12, the process of S810 is performed prior to S809. The regenerating of the check record in the rollback in S809 allows processing for the primitive (remove) received by the DB server 120 in S810 to be performed. The DB server 120 deletes the check record from control information 122 and reports to the server 110a that the check record has been successfully deleted (step S811). The server 110a makes a request for the DB server 120 to roll back processing that has started on the server-110a side to the time of S802 (step S812). In the rollback in S812, the server 110a transmits to the DB server 120 a request to change data on the account A back into the state before the process of S803. The DB server 120 performs processing that depends on the request from the server 110a, and changes data on the account A back into the state before the process of S803. In the rollback in S812, the DB server 120 does not regenerate the check record stored at the time of S802. When control information indicating that the generating of a cancel record has failed is stored in the storage unit 121, the DB server 120 decides to not regenerate the check record.

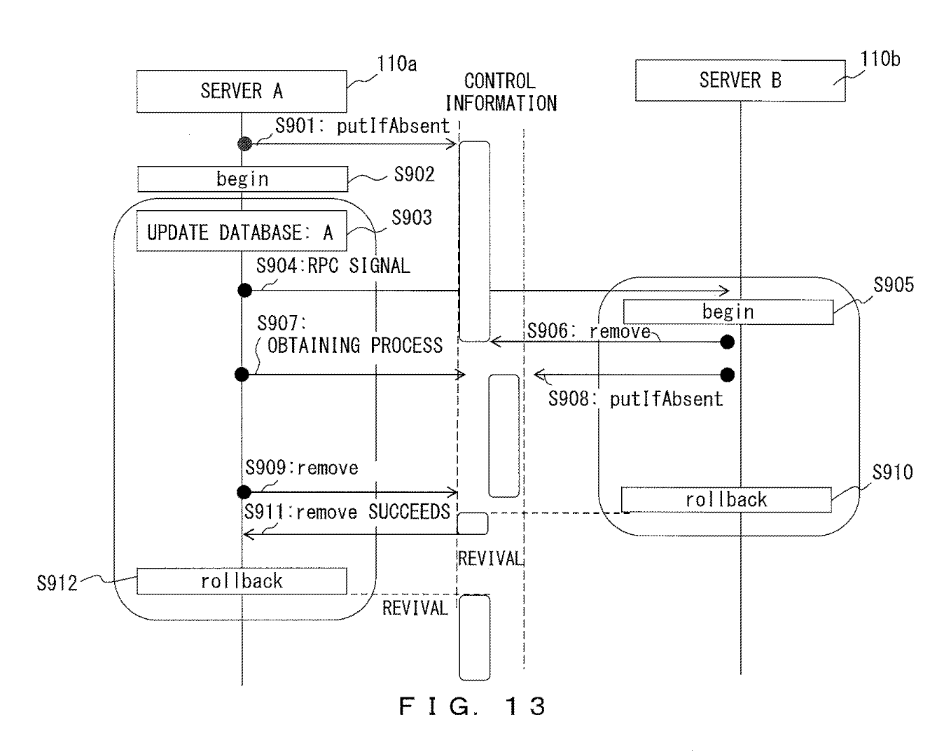

FIG. 13 is a sequence diagram illustrating an example of distributed transaction processing wherein a response signal corresponding to an RPC signal is not used (example 3). The sequence diagram in FIG. 13 depicts an example in which an RPC_ACK signal is not transmitted from the server-110b side to the server-110a side, leading to a failure in handshaking. The processes of S901-S906 in FIG. 13 are the same as the processes of S701-S706 in FIG. 11, and hence descriptions thereof are omitted herein.

After the RPC signal transmitting process in S904 is performed, the server 110a periodically obtains control information from the DB server 120 (step S907). The server 110b reports to the DB server 120 a primitive (putIfAbsent) that is an instruction to write a cancel record. The DB server 120 stores the cancel record in the storage unit 121 (step S908). The server 110b makes a request for the DB server 120 to roll back processing that has started on the server-110b side to the time of S905 (step S909). In the rollback of S909, the DB server 120 invalidates the deleting process for a check record performed in S906 and regenerates the check record. In the rollback of S909, the DB server 120 deletes the cancel record generated in S908.

When a predetermined time period has elapsed since the process of S907, the server 110a reports a primitive (remove) intended for the check record to the DB server 120. However, the DB server 120 does not have a check record stored in the storage unit 121, and hence processing for the primitive (remove) is not performed (step S910). In the sequence diagram of FIG. 13, the process of S910 is performed prior to S909. The regenerating of the check record in the rollback in S909 allows processing for the primitive (remove) received by the DB server 120 in S910 to be performed. The DB server 120 deletes the check record from control information 122 and reports to the server 110a that the check record has been successfully deleted (step S911). The server 110a makes a request for the DB server 120 to roll back processing that has started on the server-110a side to the time of S902 (step S912). In the rollback in S912, the server 110a transmits to the DB server 120 a request to change data on the account A back into the state before the process of S903. The DB server 120 performs processing that depends on the request from the server 110a, and changes data on the account A back into the state before the process of S903. In the rollback in S912, the DB server 120 does not regenerate the check record stored at the time of S902.

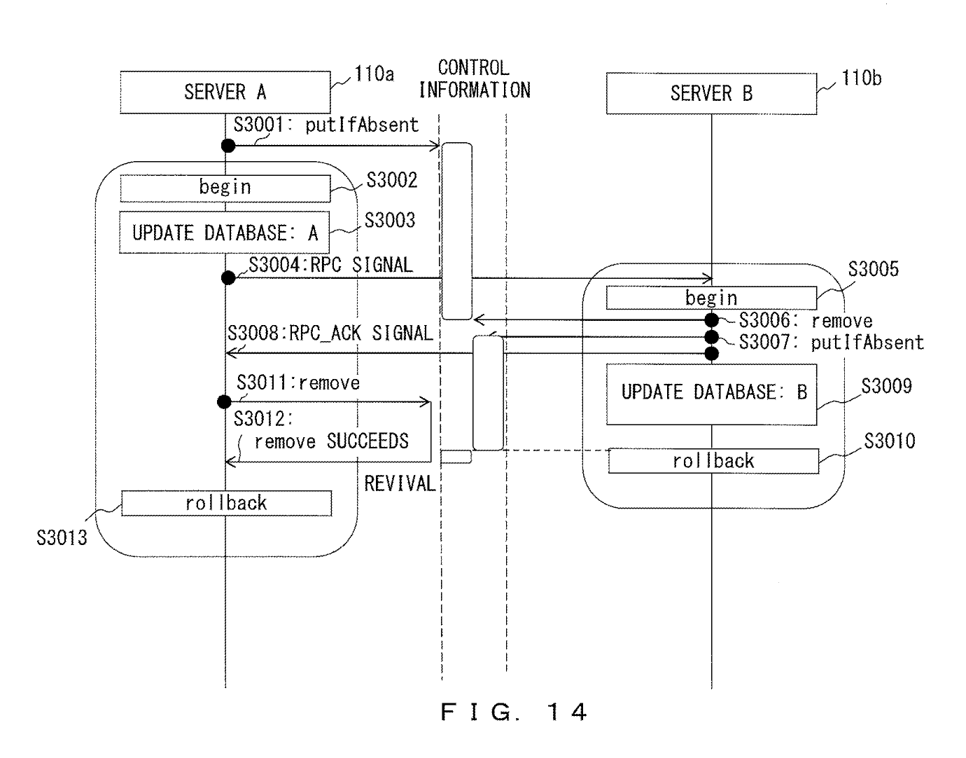

FIG. 14 is a sequence diagram illustrating an example of distributed transaction processing wherein a response signal corresponding to an RPC signal is not used (example 4). The sequence diagram of FIG. 14 depicts an exemplary situation in which an updating process on data on the account B performed by the server 110b has failed. The processes of S3001-S3009 in FIG. 14 are the same as the processes of S701-S706 in FIG. 11, and hence descriptions thereof are omitted herein.

Due to a failure that has occurred during or subsequently to the updating process on data on the account B performed in S3009, the server 110b makes a request for the DB server 120 to roll back processing that has started on the server-110b side to the time of S3005 (step S3010). The DB server 120 performs processing that depends on the request from the server 110b, and changes data on the account B back into the state before the process of S3009. In the process of S3010, the DB server 120 invalidates information stored in the storage unit 121 in 53007. In addition, in the process of S3010, the DB server 120 regenerates the check record stored in the DB server 120 at the time of S3005.

When a predetermined time period has elapsed since the process of S3008, the server 110a reports a primitive (remove) intended for the check record to the DB server 120. However, the DB server 120 does not have a check record stored in the storage unit 121, and hence processing for the primitive (remove) is not performed (step S3001). In the sequence diagram of FIG. 14, the process of S3011 is performed prior to S3010. The regenerating of the check record in the rollback in S3010 allows processing for the primitive (remove) received by the DB server 120 in S910 to be performed. The DB server 120 deletes the check record from control information 122 and reports to the server 110a that the check record has been successfully deleted (step S3012). The server 110a makes a request for the DB server 120 to roll back processing that has started on the server-110a side to the time of S3002 (step S3013). In the rollback in S3010, the server 110a changes data on the account A back into the state before the process of S3003. Accordingly, in the rollback in S3013, the server 110a transmits to the DB server 120 a request to change data on the account Aback into the state before the process of S3003. The DB server 120 performs processing that depends on the request from the server 110a, and changes data on the account A back into the state before the process of S3003. When an RPC_ACK signal has been received in S3008, the DB server 120 does not regenerate, in the rollback in S3013, the check record stored at the time of S3002.

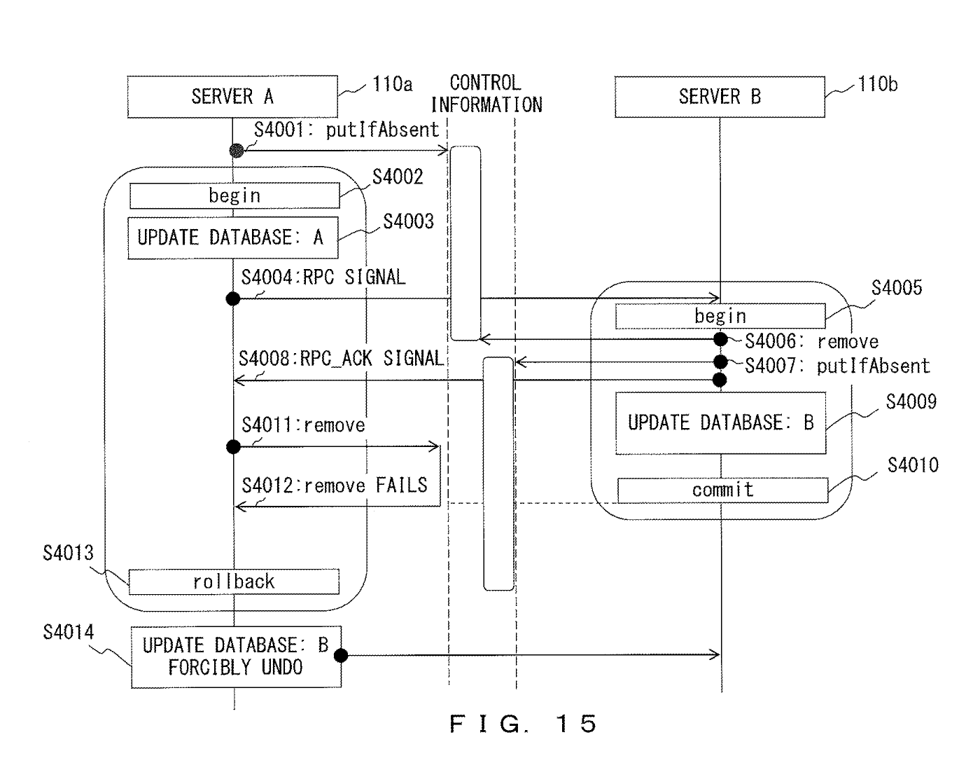

FIG. 15 is a sequence diagram illustrating an example of distributed transaction processing wherein a response signal corresponding to an RPC signal is not used (example 5). The sequence diagram of FIG. 15 depicts an exemplary situation in which, although processing on the server-110b side has been committed, processing on the server-110a side fails in processing related to a primitive (remove) and is rolled back. The processes of S4001-S4012 in FIG. 15 are the same as the processes of S701-S712 in FIG. 11, and hence descriptions thereof are omitted herein.

Despite the fact that processing on the server-110b side has been committed, the server 110a makes a request for the DB server 120 to roll back processing that has started on the server-110a side to the time of S4002 (step S4013). In the rollback in S4013, the server 110a changes data on the account A back into the state before the process of S4003. Accordingly, in the rollback in S4013, the server 110a transmits to the DB server 120 a request to change data on the account Aback into the state before the process of S4003. The DB server 120 performs processing that depends on the request from the server 110a, and changes data on the account Aback into the state before the process of S4003. An RPC_ACK signal has been received in S4008, and hence, in the rollback in S4013, the DB server 120 does not regenerate the check record stored at the time of S4002. Despite the fact that processing on the server-110b side has been committed, processing on the server-110a side has been rolled back, and hence the server 110a makes an instruction to invalidate processing on the server-110b side performed in S4009 (step S4014).

Referring to FIGS. 7, 12, 13, and 14, after processing on the server-110b side is rolled back, when the server 110a transmits a primitive (remove) to the DB server 120, the DB server 120 executes the requested instruction on the spot.

When the DB server 120 holds, as a processing object, information indicating that processing is a request process from the server 110a, i.e., the source of the RPC, the server 110a determines that processing requested by the server that is the destination of the RPC has been rolled back by the DB server 120. Then, the server 110a, i.e., the source of the RPC, makes a request for the DB server 120 to roll back the server 110a. When the server 110b, i.e., the destination of the RPC, commits processing, the server 110a, i.e., the source of the RPC, also commits processing. Hence, when rollback is performed at the destination of the RPC, the source server may perform rollback. In transaction processing, consistency is maintained between processing object data from the source of an RPC and processing object data of the destination of the RPC. Unlike in the case of two-phase commit, consistency is maintained between processing object data from the source of an RPC and processing object data of the destination of the RPC without providing a management server for managing processing of the source of the RPC and processing of the destination of the RPC.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transaction processing apparatus operated as a first processing apparatus within a system, wherein the system includes a storage that stores target data to be processed, and the first processing apparatus and a second processing apparatus, the first and second processing apparatuses making a request to process the target data, and wherein the transaction processing apparatus comprises:
a processor configured to make a request for the storage to perform a first updating process on the target data; and
an interface configured to transmit a request signal to the second processing apparatus after the first updating process ends, the request signal being for making a request to start a second updating process indivisible from the first updating process, wherein after a request to perform the second updating process is made, when the processor obtains information indicating that the target data has been subjected to a process that the first processing apparatus has made a request to perform, the processor makes a request for the storage to return the target data to a state before the first updating process.

2. The transaction processing apparatus according to claim 1, wherein
the interface receives from the second processing apparatus a response signal that includes information indicating whether the second updating process has been finished normally, wherein
when the interface does not receive the response signal for a predetermined time period, the processor makes a request for the maintaining apparatus to return the target data to the state before the first updating process.

3. The transaction processing apparatus according to claim 1 wherein
the interface receives from the second processing apparatus a response signal indicating whether the second updating process has been finished normally, wherein
when the interface receives a response signal indicating that the second updating process has been finished normally, the processor performs a finalizing process for the first updating process, and
when the interface receives a response signal indicating that the second updating process has failed, the processor makes a request for the maintaining apparatus to return the target data to the state before the first updating process.

4. A transaction processing apparatus operated as a second processing apparatus within a system, wherein the system includes a storage that stores target data to be processed, and a first processing apparatus and the second processing apparatus, the first and second processing apparatuses making a request to process the target data, and wherein the transaction processing apparatus comprises:
a interface configured to receive, after a first updating process performed by the storage on the target data within the storage ends, a request signal for making a request to start a second updating process indivisible from the first updating process; and
a processor configured to make a request for the storage to perform a second updating process on the target data and when the second updating process is not performed normally, perform control for making a request for the storage to return the target data to a state before start of the second updating process, and a request for the storage to regenerate information on a processing apparatus that has made a request to perform the first updating process on the target data.

5. A non-transitory computer readable recording medium having stored therein a transaction processing program to be executed by a processing apparatus operated as a first processing apparatus within a system, wherein the system includes a storage that stores target data to be processed, and the first processing apparatus and a second processing apparatus, the first and second processing apparatuses making a request to process the target data, and wherein the transaction processing program causes the processing apparatus to perform a process comprising:
making a request for the storage to perform a first updating process on the target data;
transmitting a request signal to the second processing apparatus after the first updating process ends, the request signal being for making a request to start a second updating process indivisible from the first updating process;
obtaining, from the storage, information on a processing apparatus that has made a request to perform a process that has been performed on the target data; and
after a request to perform the second updating process is made, when information is obtained that indicates that the target data has been subjected to a process that the first processing apparatus has made a request to perform, making a request for the storage to return the target data to a state before the first updating process.

6. The non-transitory computer-readable recording medium according to claim 5, wherein the transaction processing program causes the processing apparatus to perform a process comprising:
receiving from the second processing apparatus a response signal that includes information indicating whether the second updating process has been finished normally; and
when the response signal is not received for a predetermined time period, making a request for the maintaining apparatus to return the target data to the state before the first updating process.

7. The non-transitory computer-readable recording medium according to claim 5, wherein the transaction processing program causes the processing apparatus to perform a process comprising:
receiving from the second processing apparatus a response signal that includes information indicating whether the second updating process has been finished normally;
when the response signal indicating that the second updating process has been finished normally is received, performing a finalizing process for the first updating process; and
when a response signal indicating that the second updating process has failed is received, making a request for the maintaining apparatus to return the target data to the state before the first updating process.

8. A non-transitory computer-readable recording medium therein a transaction processing program to be executed by a processing apparatus operated as a second processing apparatus within a system, wherein the system includes a storage that stores target data to be processed, and a first processing apparatus and the second processing apparatus, the first and second processing apparatuses making a request to process the target data, and wherein the transaction processing program causes the processing apparatus to perform a process comprising:
after a first updating process performed by the storage on the target data within the storage ends, receiving a request signal for making a request to start a second updating process indivisible from the first updating process;
making a request for the storage to perform a second updating process on the target data; and
when the second updating process is not performed normally, performing control for making a request for the storage to return the target data to a state before start of the second updating process, and a request for the storage to regenerate information on a processing apparatus that has made a request to perform the first updating process on the target data.

9. A distributed processing system comprising:
a storage configured to store target data to be processed and information on a processing apparatus that has made a request to perform a process that has been performed on the target data;
a first processing apparatus configured to make a request for the storage to perform a first updating process on the target data; and
a second processing apparatus configured to make a request for the storage to perform a second updating process on the target data, the second updating process being indivisible from the first updating process, wherein
when the first processing apparatus makes a request to perform the second updating process after the first updating process ends, the second processing apparatus makes a request for the storage to perform the second updating process, and
when the second updating process is not performed normally, the second processing apparatus makes a request for the storage to return the target data to a state before start of the second updating process, and a request for the storage to regenerate information on a processing apparatus that has made a request to perform the first updating process on the target data, and
after a request to perform the second updating process is made, when the first processing apparatus obtains information indicating that the target data has been subjected to a process that the first processing apparatus has made a request to perform, the first processing apparatus makes a request for the storage to return the target data to a state before the first updating process.

10. The distributed processing system according to claim 9, wherein
the first processing apparatus receives from the second processing apparatus a response signal that includes information indicating whether the second updating process has been finished normally, and
when the response signal is not received for a predetermined time period, the first processing apparatus makes a request for the maintaining apparatus to return the target data to the state before the first updating process.

11. The distributed processing system according to claim 9, wherein
the first processing apparatus
receives from the second processing apparatus a response signal that includes information indicating whether the second updating process has been finished normally,
when the response signal indicating that the second updating process has been finished normally is received, performs a finalizing process for the first updating process, and
when a response signal indicating that the second updating process has failed is received, makes a request for the maintaining apparatus to return the target data to the state before the first updating process.
